(19) United States
(12) Patent Application Publication
(10) Pub. No.: US 2025/0048106 A1
(43) Pub. Date: Feb. 6, 2025

(54) NETWORK-EVENT DATA BASED DETECTION OF ROGUE UNMANNED AERIAL VEHICLES

(71) Applicant: Telefonaktiebolaget LM Ericsson (publ), Stockholm (SE)

(72) Inventors: Alfonso De Jesus PEREZ MARTINEZ, MADRID (ES); Rodrigo ALVAREZ DOMINGUEZ, MADRID (ES); Miguel Angel MUÑOZ DE LA TORRE ALONSO, MADRID (ES)

(73) Assignee: Telefonaktiebolaget LM Ericsson (publ), Stockholm (SE)

(21) Appl. No.: 18/722,196

(22) PCT Filed: Mar. 4, 2022
(86) PCT No.: PCT/EP2022/055556

§ 371 Date: Jun. 20, 2024

(30) Foreign Application Priority Data
Dec. 21, 2021 (EP) 21383185.2

(51) Int. Cl. H04W 12/122; H04W 24/10

(52) U.S. Cl. CPC H04W 12/122; H04W 24/10

(57) ABSTRACT

A node (130) of a wireless communication network obtains event data related to one or more wireless devices (10) connected to the wireless communication network. Based on analyzing the event data, the node (130) detects that at least one of the one or more wireless devices corresponds to a rogue UAV. Further, the node (130) reports the detected at least one wireless device to an aircraft traffic management system.

### TECHNICAL FIELD

The present invention relates to methods for controlling wireless communication and to corresponding devices, systems, and computer programs.

### BACKGROUND

In wireless communication networks, e.g., based on the 4G (4^{th} Generation) LTE (Long Term Evolution) or 5G (5^{th} Generation) NR technology as specified by 3GPP (3^{rd} Generation Partnership Project), various kinds of devices may be provided with network connectivity. One type of such devices are unmanned aerial vehicles (UAVs), which are often also referred to as “drones”. Such UAV is an aircraft without a human pilot on board. UAVs may be part of an unmanned aerial system (UAS), which includes one or more UAVs, a ground-based controller, and a system of communications between the controller and the UAV. The UAV(s) may operate with various degrees of autonomy, one extreme case being complete remote control by a human operator and another extreme case being autonomous control by onboard computers, also referred to as an autopilot. Exemplary usages of UAVs include military applications, aerial photography, product deliveries, agriculture, policing and surveillance, infrastructure inspections, science, smuggling and drone racing.

Unmanned aircraft system traffic management (UTM) is an air traffic management ecosystem under development for autonomously controlled operations of unmanned aerial systems (UAS). A current focus in the development of UTM is includes concepts of operation, data exchange requirements, and a supporting framework to enable multiple UAS operations beyond visual line-of-sight at altitudes under 400 ft above ground level in airspace where public air traffic services are not provided.

For UAS, wireless connectivity offered by a 3GPP wireless communication network may offer various benefits like ubiquitous coverage, high reliability and QoS (Quality of Service), robust security, and seamless mobility, which may be critical factors to support UAS command and control functions.

The 3GPP wireless communication network can provide control plane and user plane communication services for UAS. Examples of services which can be offered to the UAS ecosystem includes data services for command and control, telematics, UAS-generated data, remote identification, and authorization, enforcement, and regulation of UAS operation. An architecture to support UAS by a 3GPP wireless communication network is for example described in 3GPP TR 23.754 V17.1.0 (March 2021).

Also private and civil drones are subject to regulations and may need authorization according to the type of flight, so that a private and civil UAS ecosystem can safely coexist with commercial air traffic, public and private infrastructure, and the general population. So a mobile network operator (MNO) may provide radio coverage in the areas where a UAV is going to fly, and such network connectivity may be used for transmitting real time information to control UAS operations beyond visual line-of-sight and at altitudes under 400 ft above ground level in airspace where public air traffic services are not provided. Such UAVs may be controlled based on authorizations from an UAS Traffic Management (UTM), as described in 3GPP TR 23.754 V17.1.0.

However, there is a possibility of UAVs that are not registered as such, e.g., operate on the basis of a regular mobile-broadband subscription, without being registered at the UTM. Such rogue UAVs may lead to various risks, in particular to other UAVs and other air traffic, but also to the people or facilities on ground.

Accordingly, there is a need for efficiently controlling wireless communications related to UAVs.

### SUMMARY

According to an embodiment, a method of controlling wireless communication is provided. According to the method, a node of a wireless communication network obtains event data related to one or more wireless devices connected to the wireless communication network. Based on analyzing the event data, the node detects that at least one of the one or more wireless devices corresponds to a rogue UAV. Further, the node reports the detected at least one wireless device to an aircraft traffic management system.

According to a further embodiment, a node for a wireless communication network is provided. The node is configured to obtain event data related to one or more wireless devices connected to the wireless communication network. Further, the node is configured to, based on analyzing the event data, detect that at least one of the one or more wireless devices corresponds to a rogue UAV. Further, the node is configured to report the detected at least one wireless device to an aircraft traffic management system.

According to a further embodiment, a node for a wireless communication network is provided. The node comprises at least one processor and a memory. The memory contains instructions executable by said at least one processor, whereby the node is operative to obtain event data related to one or more wireless devices connected to the wireless communication network. Further, the memory contains instructions executable by said at least one processor, whereby the node is operative to, based on analyzing the event data, detect that at least one of the one or more wireless devices corresponds to a rogue UAV. Further, the memory contains instructions executable by said at least one processor, whereby the node is operative to report the detected at least one wireless device to an aircraft traffic management system.

According to a further embodiment of the invention, a computer program or computer program product is provided, e.g., in the form of a non-transitory storage medium, which comprises program code to be executed by at least one processor of a node for a wireless communication network. Execution of the program code causes the node to obtain event data related to one or more wireless devices connected to the wireless communication network. Further, execution of the program code causes the node to, based on analyzing the event data, detect that at least one of the one or more wireless devices corresponds to a rogue UAV. Further, execution of the program code causes the node to report the detected at least one wireless device to an aircraft traffic management system.

Details of such embodiments and further embodiments will be apparent from the following detailed description of embodiments.

### BRIEF DESCRIPTION OF THE DRAWINGS

FIG. 1 schematically illustrates a wireless communication network according to an embodiment of the invention.

FIG. 2 schematically illustrates an UAV management architecture according to an embodiment of the invention.

FIG. 3 schematically illustrates an analytics system according to an embodiment of the invention.

FIGS. 4A and 4B schematically illustrates an example of processes according to an embodiment of the invention.

FIG. 5 shows a flowchart for schematically illustrating a method according to an embodiment of the invention.

FIG. 6 shows an exemplary block diagram for illustrating functionalities of a network node implementing functionalities corresponding to the method of FIG. 6.

FIG. 7 schematically illustrates structures of a network node according to an embodiment of the invention.

### DETAILED DESCRIPTION

In the following, concepts in accordance with exemplary embodiments of the invention will be explained in more detail and with reference to the accompanying drawings. The illustrated embodiments relate to controlling of wireless communication related to UAVs. The UAVs are assumed to have wireless connectivity to a wireless communication network, e.g., based on the NR technology or on the LTE technology as specified by 3GPP.

In the illustrated concepts, an analytics system within the wireless communication network may be used to detect rogue UAVs among UEs connected to the wireless communication network. Such rogue UAV may correspond to a UAV which is not registered as such and/or is not authorized by an UTM. The rogue UAV may for example uses a regular MBB subscription for connecting to the wireless communication network. The detection of the rogue UAV(s) is achieved based on analytics of collected event data. The analytics may be based on an NWDAF (Network Data Analytics Function) of the wireless communication network. The identified rogue UAV(s) may then be reported to a UTM and/or one or more actions may be triggered with respect to the detected rogue UAV(s), such as blocking of the connection of the rogue UAV, deactivating an MBB subscription associated with the rogue UAV, or redirecting data traffic of the detected rogue UAV. By detecting the rogue UAV(s) based on the event data, rogue UAVs may be identified in an automated manner in real time, and safety of UAS operation can thus be improved by preventing potential hazards created by the rogue UAV(s).

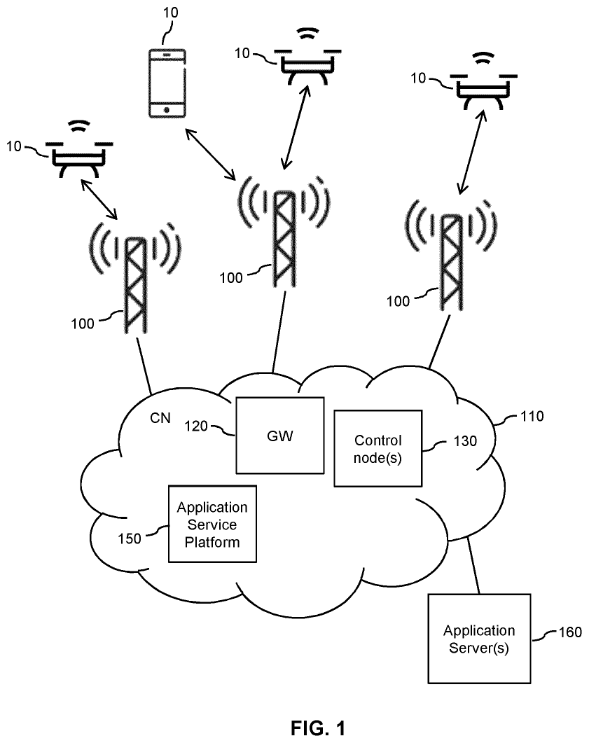

FIG. 1 illustrates exemplary structures of the wireless communication network. In particular, FIG. 1 shows multiple UEs 10 which are served by access nodes 100 of the wireless communication network. Here, it is noted that each access node 100 may serve a number of cells within the coverage area of the wireless communication network. Depending on the supported RAT(s) each access nodes 100 may correspond to a gNB of the NR technology or an eNB of the LTE technology. The access nodes 100 may each be regarded as being part of an RAN of the wireless communication network. Further, FIG. 1 schematically illustrates a CN (Core Network) 110 of the wireless communication network. In FIG. 1, the CN 110 is illustrated as including a GW (gateway) 120 and one or more control node(s) 130. The GW 120 may be responsible for handling UP traffic of the UEs 10, e.g., by forwarding user data traffic from a UE 10 to a network destination or by forwarding user data traffic from a network source to a UE 10. Here, the network destination may correspond to another UE 10, to an internal node of the wireless communication network, or to an external node which is connected to the wireless communication network. Similarly, the network source may correspond to another UE 10, to an internal node of the wireless communication network, or to an external node which is connected to the wireless communication network. The control node(s) 130 may be used for controlling the user data traffic, e.g., by providing control data to the access node 100, the GW 120, and/or to the UE 10.

As illustrated by double-headed arrows, the access node 100 may send DL transmissions to the UEs, and the UEs may send UL transmissions to the access nodes 100. The DL transmissions and UL transmissions may be used to provide various kinds of services to the UEs, e.g., a voice service, a multimedia service, or a data service. Such services may be hosted in the CN 110, e.g., by a corresponding network node. By way of example, FIG. 1 illustrates an application service platform 150 provided in the CN 110. Further, such services may be hosted externally, e.g., by an AF (application function) connected to the CN 110. By way of example, FIG. 1 illustrates one or more application servers 160 connected to the CN 110. The application server(s) 160 could for example connect through the Internet or some other wide area communication network to the CN 110. The application service platform 150 may be based on a server or a cloud computing system and be hosted by one or more host computers. Similarly, the application server(s) 160 may be based on a server or a cloud computing system and be hosted by one or more host computers. The application server(s) 160 may include or be associated with one or more AFs that enable interaction with the CN 110 to provide one or more services to the UEs 10, corresponding to one or more applications. These services or applications may generate the user data traffic conveyed by the DL transmissions and/or the UL transmissions between the access node(s) 100 and the respective UE 10. Accordingly, the application server(s) 160 may include or correspond to the above-mentioned network destination and/or network source for the user data traffic. In the respective UE 10, such service may be based on an application (or shortly “app”) which is executed on the UE 10. Such application may be pre-installed or installed by the user. Such application may generate at least a part of the UP traffic between the UE 10 and the access node 100.

In the following description, it is assumed that the wireless communication network is based on a 5G system (5GS) architecture as for example specified 3GPP TS 23.501 V17.2.0 (2021-09). Accordingly, exemplary nodes of the CN 110 may include a UPF (User Plane Function), an AMF (Access and Mobility Management Function), an SMF (Session Management Function), a PCF (Policy Control Function), a UDR (Unified Data Repository), an NWDAF, and an NEF (Network Exposure Function). These CN nodes and interfaces connecting these CN nodes can be implemented as specified in 3GPP TS 23.501 V17.2.0. In the 5GS, the AF interacts with the CN 110 and allows external parties to use different Exposure APIs (Application Programming Interfaces) offered by the network operator and exposed by the NEF.

The UDR stores data grouped into distinct collections of subscription-related information, including subscription data, policy data, structured data for exposure to third parties, and application data. The AMF manages access of UEs to the wireless communication network, including management of connection via different access networks, and UE mobility aspects, such as handovers between different access nodes or between different access technologies. The PCF provides a unified policy framework to govern the network behavior. Specifically, the PCF may provide PCC (Policy and Charging Control) rules to a PCEF (Policy and Charging Enforcement Function), e.g., implemented by the SMF or UPF, that enforces policy and charging decisions according to the provisioned PCC rules. The UPF supports handling of user plane traffic based on the rules received from the SMF, e.g., packet inspection and enforcement of QoS (QOS) rules. The SMF may receive PCC rules from the PCF and configures the UPF accordingly.

The NWDAF may support various types of network analytics, based on interaction with various entities. The network analytics may be provided as services to one or more consumers. In the illustrated concepts, the NWDAF may provide a service corresponding to the detection of rogue UAVs to a UTM. Accordingly, the UTM may be an NF which acts as a consumer of the service “detection of rogue UAVs”. The functionalities of the NWDAF may include data collection based on event subscription. The collected data may be provided by one or more of: AMF, SMF, PCF, UDM (Unified Data Management), AF (directly or via NEF), and OAM (Operations, Administration, and Maintenance). Further, the functionalities of the NWDAF may include retrieval of information from data repositories, e.g., from UDR via UDM for subscriber-related information, retrieval of information about NFs (Network Functions), e.g., from an NRF (Network Repository Function) for NF-related information, and/or from an NSSF (Network Slice Selection Function) for slice-related information.

In the example of FIG. 1, the GW 120 may correspond to the UPF, and the control nodes 130 may include the SMF, AMF, PCF, UDR, NEF, and NWDAF.

As illustrated, some of the UEs 10 connected to the wireless communication network may correspond to UAVs. Such UAV may be registered and authorized by a UTM. However, it is also possible that such UAV is a rogue UAV and not registered and authorized by a UTM. Such rogue UAV could utilize a regular MBB subscription and, from the perspective of the mobile communication network, would appear as a mobile phone or similar MBB device. In the illustrated concepts, such rogue UAVs may be detected by the NWDAF based on analytics of collected event data. The NWDAF may then report the detected rogue UAV(s) to the UTM and/or trigger one or more actions to reduce or prevent hazards caused by the rogue UAV(s).

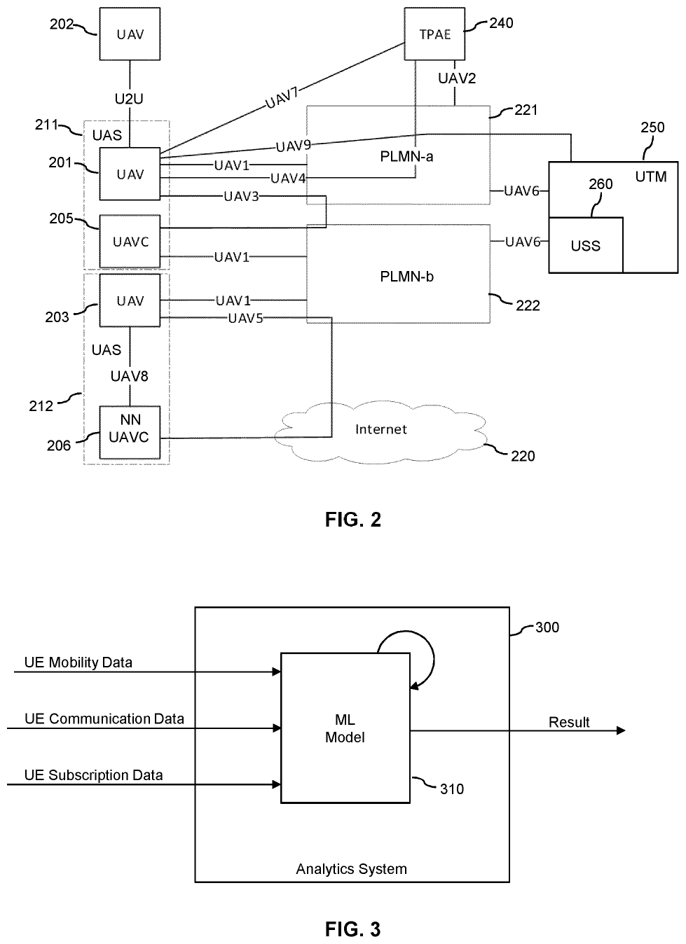

The illustrated concepts may be applied in a UAV architecture as for example described in 3GPP TR 23.754 17.1.0 and illustrated in FIG. 2. In the architecture of FIG. 2, a 3GPP system enables a UTM 250 to associate a UAV and UAV controller (UAVC). The UTM 250 includes a USS (UAS Service Supplier) 260, which provides functionalities like bridging communication between UAS operators and Flight Information Management System (FIMS), supporting planning of UAS operations, assisting strategic deconfliction of the UTM airspace, providing information support to UAS operators during operations, and helping UAS operators meet their formal requirements.

FIG. 2 illustrates UAVs 201, 202, and 203 as well as UAVCs 205 and 206. UAV 201 and UAVC 205 form a first UAS 211. UAV 203 and UAVC 206 form a second UAS 212. UAV are controlled by UAVC 205. The UAVC can be networked, i.e., have direct wireless connectivity to the 3GPP system through a PLMN (Public Land Mobile Network), as illustrated for UAVC 205. Alternatively, the UAVC can be without direct wireless connectivity to the 3GPP system through a PLMN. UAVC 206 is an example of such non-networked (NN) UAVC. The serving PLMN of the UAV(s) and the serving PLMN of the corresponding UAVC can be different, like illustrated for UAV 201, which is connected to a first PLMN 221, denoted as PLMN-a, while the corresponding UAVC 205 is connected to a second PLMN 222, denoted as PLMN-b. It is noted that from the perspective of the 3GPP system, each networked component of a UAS, i.e., UAV and UAVC, is considered as an individual UE.

In the architecture of FIG. 2, authentication and authorization of UAVs may be based on the following principles: The UAV is authenticated at registration in the 3GPP system using the existing UE authentication mechanisms based on MNO (Mobile Network Operator) credentials. In addition, UAV-USS-registration takes place between the UAV and the USS 260/UTM 250. The UAV-USS-registration typically involves authorization of the UAV and may also involve authentication of the UAV. UAV-USS-registration is distinct from authorization and authentication of the UAV as UE in the 3GPP system. However, once UAV-USS-registration is performed the USS 260/UTM 250 may inform the 3GPP system accordingly. Authorization and authentication of the UAV with the UTM 250 may be triggered when the UAV accesses the 3GPP system. In the case of a rogue UAV, the UE corresponding to the UAV would be registered and connected to the 3GPP system, but the UAV would not be registered, authorized or authenticated by the UTM 250.

In the architecture of FIG. 2, an interface denoted as UAV1 interfaces the UAV and UAVC with the 3GPP system to support UAV and UAVC authorization, authentication, identification, and tracking. An interface denoted as UAV2 interfaces a TPAE (Third Party Authorized Entity) 240 with the 3GPP system for remote identification and tracking. An interface denoted as UAV3 provides 3GPP user plane connectivity for transporting C2, which an application-level protocol for command and control. The UAV3 interface can be intra-PLMN or inter-PLMN. An interface denoted as UAV4 interfaces a TPAE 240 with a UAV over 3GPP network for C2 and RID (Remote Identification) and tracking of the UAV. An interface denoted as UAV5 is similar to UAV3 and used for transporting C2, but interfaces a UAV with a non-networked (NN) UAVC via the Internet 220, like illustrated for UAVC 206. An interface denoted as UAV6 interfaces the 3GPP system with the USS 260/UTM 250 for functionality exposure, support of identification and tracking, and UAV authorization. An interface denoted as UAV7 is used for RID information sent in broadcast (BRID) outside the 3GPP system. An interface denoted as UAV8 is used for C2 over a transport network outside the 3GPP system. An interface denoted as UAV9 supports connectivity between the UAV or a networked UAVC and the USS 260/UTM 250 for UAS management, such as authentication and authorization, transporting C2, networked remote identification (NRID) and tracking of the UAV. An interface denoted as U2U supports UAV to UAV communications for broadcast RID. At any given time, a UAV may be controlled mutually exclusively by an UAVC, a TPAE, or the UTM. Therefore, C2 to a UAV may be either over UAV3, UAV4, or UAV9.

In the illustrated concepts, the MNO can automate the process of detecting rogue UAVs that have not been authorized by UTM. In the following, an example of a mechanism will be explained in more detail, which is based on analytics performed by the NWDAF. The mechanism allows to expose results of the analytics information, e.g., to the UTM 250, and to automatically trigger actions in the wireless communication network.

In the following, it is assumed that the UTM 250 has a capability to list all authorized UAVs in a certain area. These registered UAVs may for example have previously registered in the UTM 250 and indicated their respective flight path to the UTM 250. In some cases, the UTM 250 could identify a suspicious UAV flying in some area, e.g., a forbidden or open area, that is not authorized or has not been registered previously in UTM. The UTM 250 may then check which the MNO(s) potentially supporting that UAV. However, it could also be possible that this UAV is not controlled through a wireless communication network. The UTM 250 may ask the MNO(s) mobile operator/s for all possible UAVs flying in the considered area because there might be a rogue UAV. The MNO may then respond with a list of UEs which, from the perspective of the MNO, could correspond to rogue UAVs operating in the considered area. The detection of the rogue drones may be based on a trained ML model which is applied by the NWDAF. The training of the ML model can be based on tagged date collected for the authorized UAVs and thus reflecting typical behavior of a UAV. In addition or as an alternative, the detection of the rogue UAVs can also be based on subscription data, e.g., by identifying UEs associated with a regular MBB subscription but having a mobility pattern and/or communication pattern which corresponds to a UAV.

In the illustrated mechanism, the UTM 250 may request the MNO, e.g., through the NEF, to detect and report rogue UAVs. In addition to the reporting action, the UTM 250 could also request the MNO to apply other actions, e.g., to redirect traffic towards a network security entity or towards a specific network slice, to block traffic, to tear down connections, or to apply an authentication service. For this purpose, a service on the Nnef interface between AF and NEF, denoted as “Nnef_AnalyticsExposure_Subscribe” and specified in 3GPP TS 23.288 V17.2.0 (2021 September) may be extended as follows: A Nnef_AnalyticsExposure_Subscribe request may include an AF Identfier (AF-ID) which identifies the UTM, an Analytic-Identifier (Analytic-ID) set to “Abnormal behaviour”, and an Analytic-Type set to “Rogue UAV”, thereby indicating that analytics of abnormal behavior are to be performed with the aim of identifying rogue UAVs. Further, the request indicates a Target of Analytics Reporting, which can be a UE Identifier (UE-ID) or a list of UE-IDs, a UE-Group Identifier (UE-Group-ID) or a list of UE-Group-IDs, or “AnyUE”. This information indicates the UE(s) which are the target for this analytic. When the information is not present, the setting “AnyUE” applies, i.e., the analytic is targeted to any UE. Further, the request may include analytics filter Information, such as area of interest and optionally other filter information like Data Network Name (DNN), Single Network Slice Selection Assistance Information (S-NSSAI), and/or Radio Access Technology Type (RAT-Type). Further, the request may include TimePeriod information, such as “daily” or “hourly”. Further, the request may indicate a confidence level required by the UTM. Further, the request may indicate a Requested-Action. This information may indicate one or more action(s) to be applied to the detected rogue UAVs. Examples of such actions are: redirect traffic towards a network security entity or towards a certain slice, e.g., dedicated to handling rogue UAV traffic, block traffic or tear down connections, and/or request the MNO to disable the MBB subscription associated with the rogue UAV. A further example of such actions is to report traffic towards an analytics engine, e.g., to the NWDAF, which can use this information for training ML models for rogue UAV detection. A still further example of such actions is to request the MNO to apply an authentication service, to redirect all non-authenticated connections to an authentication server. The request may also include a list of UAVs registered by the UTM 250. Such list of registered UAVs could be used by the MNO to cross-check with a list of UAVs registered at the MNO.

The NEF may be responsible for authorizing the request from the UTM, e.g. by checking it is requested by an authorized UTM entity, and for forwarding the request to the NWDAF, using a service on the Nnwdaf interface between NEF and NWDAF denoted as “Nnwdaf_AnalyticsSubscription_Subscribe” and specified in 3GPP TS 23.288 V17.2.0. Based on this analytics subscription, the NWDAF triggers data collection from the UDR, AMF, and UPF. The data collection from the UDR relates to subscription data, e.g., to retrieve the subscriptions, in particular UE-IDs, which are not registered as UAV or other IoT (Internet of Things) subscriptions. The data collection from the AMF relates to UE mobility. The data collection from the UPF relates to UE communication. In some cases, the data collection from the UPF may be through the SMF.

Based on the collected data, the NWDAF performs analytics to detect one or more UE-IDs which correspond to rogue UAVs. These analytics may be based on a trained ML model. The output of the analytics generated by the NWDAF includes the corresponding Analytic-ID, i.e., “Abnormal behaviour” and Analytic-Type, i.e., “Rogue UAV”, and an Analytic-Result. The information element denoted as “Analytic-Result” includes a list of UE-IDs detected as corresponding to rogue UAVs. For each UE-ID in the list, the Analytic-Result may indicate position and estimated trajectory of the UE. Further, the Analytic-Result may indicate a confidence metric which indicates a confidence level that the UE is a rogue UAV. The confidence level may be indicated as a percentage value. The NWDAF provides the output through the NEF to the UTM 250. Based on the reported analytics result, the UTM may apply actions like adaptation of UTM operations to consider the detected rogue UAV(s) and avoid hazardous situations. Further, also the MNO may apply the actions indicated by the Requested-Action.

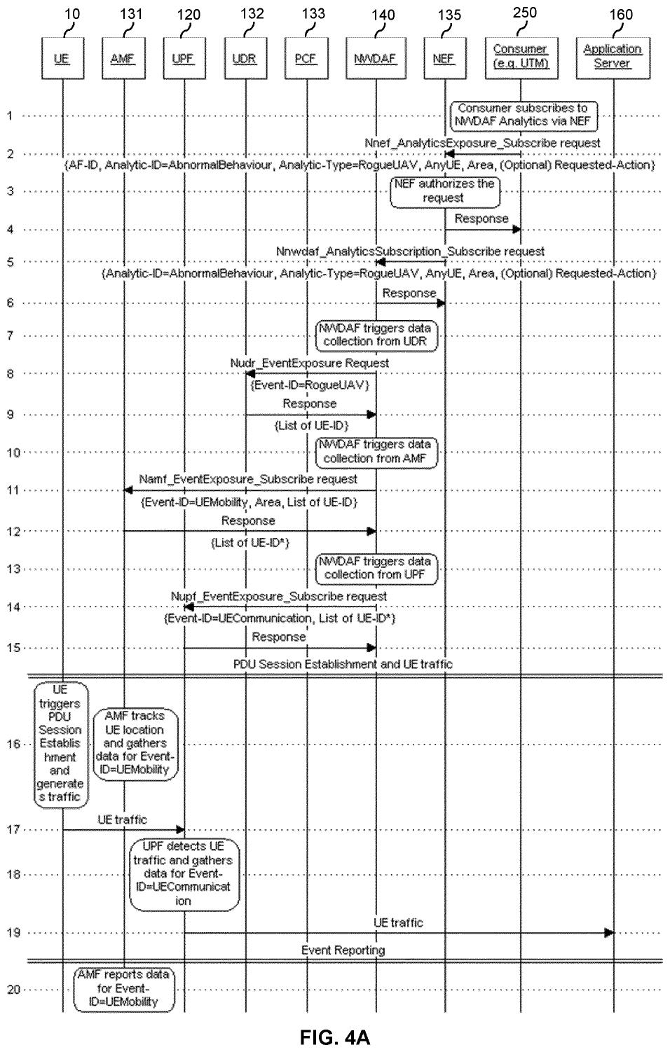

FIG. 3 schematically illustrates usage of Machine learning (ML) in the illustrated concepts. In particular, FIG. 3 illustrates an analytics system 300 which may for example implement the above-described analytics performed by the NWDAF. ML may be regarded as a form of artificial intelligence (AI). As illustrated, the analytics system 300 includes an ML model 310 which receives UE mobility data, UE communication data, and UE subscription data as input. The ML model 310 may be based on various kinds of ML algorithm, e.g., supervised learning, unsupervised learning, or reinforcement learning. Supervised learning could for example be based on Regression, Decision Tree, Random Forest, KNN (K-Nearest Neighbors), or Logistic Regression. Unsupervised learning could for example be based on K-means, mean-shift clustering, Density-Based Spatial Clustering of Applications with Noise (DBSCAN), Expectation-Maximization (EM) Clustering using Gaussian Mixture Models (GMM), Agglomerative Hierarchical Clustering. Reinforcement learning could for example be based on a Markov Decision Process. Irrespective of the specific utilized ML algorithm, the ML model 310 is trained on the basis of training data, with the aim of enabling the ML model 310 to make predictions or decisions, in particular to conclude from the input data whether a certain UE corresponds to a rogue UAV. Such information is output as a result from the ML model 310. The training data may for example include UE mobility data, UE communication data, and UE subscription data collected for registered and authorized UAVs and/or data collected for UEs which are known to be rogue UAVs.

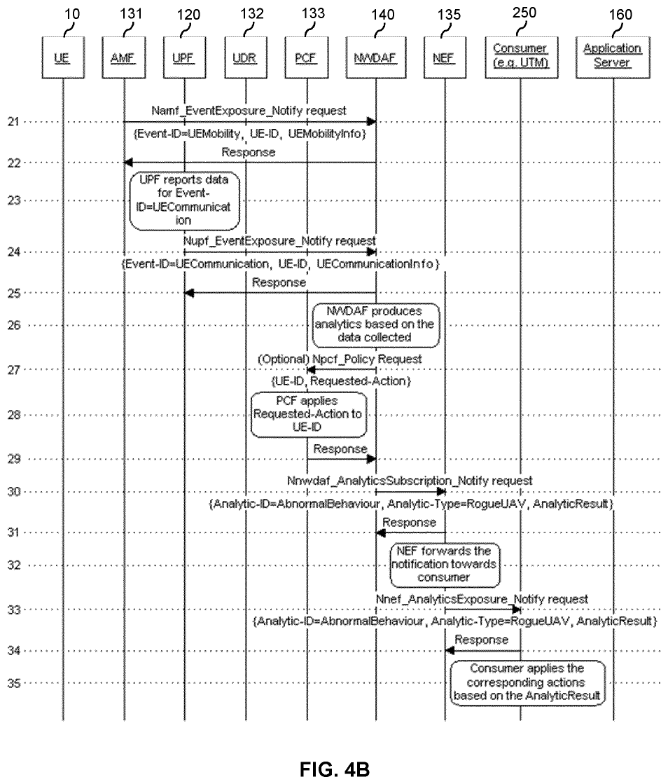

FIGS. 4A and 4B illustrate exemplary processes for further illustrating the illustrated concepts. The processes of FIGS. 4A and 4B involve the UE 10, the AMF 131, the UPF 120, the UDR 132, the PCF 133, the NWDAF 140, the NEF 135, the service consumer, e.g., UTM 250, and the application server 160.

At steps 1 and 2, the consumer 250, acting as an AF, requests the MNO through the NEF 135 to detect and report rogue UAVs. In addition to the reporting action, the consumer might also request the MNO to apply other actions, e.g., redirect traffic towards a network security entity or towards a specific slice, block traffic, tear down connections, apply an authentication service. For this purpose, the consumer 250 sends an Nnef_AnalyticsExposure_Subscribe request to the NEF 135. The request may include an AF-ID which identifies the consumer 250, an Analytic-ID set to “Abnormal behaviour”, and an Analytic-Type set to “Rogue UAV”. Further, the request may include a Target of Analytics Reporting, which can be a UE-ID or a list of UE-IDs, a UE-Group-ID or a list of UE-Group-IDs, or “AnyUE”. This information indicates the UE(s) which are the target for this analytic. When the information is not present, the setting “AnyUE” applies, i.e., the analytic is targeted to any UE. Further, the request may include analytics filter Information, such as area of interest and optionally other filter information like DNN, S-NSSAI, and/or RAT-Type. Further, the request may include TimePeriod information, such as “daily” or “hourly”. This information indicates a time period to which the analytic is to be applied. It is however noted that whenever an rogue UAV is detected, it may be immediately reported to the consumer 250. However, the report could also be periodic, e.g. every 5 minutes. Further, the request may indicate a confidence level required by the consumer 250. Further, the request may indicate a Requested-Action. This information may indicate one or more action(s) to be applied to the detected rogue UAVs. Examples of such actions are: redirect traffic towards a network security entity or towards a certain slice, e.g., dedicated to handling rogue UAV traffic, block traffic or tear down connections, and/or request the MNO to disable the MBB subscription associated with the rogue UAV. A further example of such actions is to report traffic towards an analytics engine, e.g., to the NWDAF 140, which can use this information for training ML models for rogue UAV detection. A still further example of such actions is to request the MNO to apply an authentication service, to redirect all non-authenticated connections to an authentication server.

The request from the consumer 250 may also include a list of UAVs registered by the UTM. Such list of registered UAVs could be used by the MNO to cross-checks with a list of UAVs registered at the MNO.

At steps 3, 4 and 5, the NEF 135 authorizes the request from the consumer 250, e.g., by checking that the request is from an authorized UTM entity, confirms authorization to the consumer 250, and forwards the request to the NWDAF 140, by sending an Nnwdaf_AnalyticsSubscription_Subscribe request including the information explained in connection with step 2. At step 6 the NWDAF 140 confirms successful operation to the NEF 135.

At steps 7 and 8, the NWDAF 140 triggers data collection from the UDR 132 with respect to subscription data, e.g., to retrieve the subscriptions (UE-IDs) which are not registered as UAV or other IoT (Internet of Things) subscriptions. This involves that the NWDAF 140 sends a Nudr_EventExposure request, including an event identfier (Event-ID) set to “RogueUAV”, to the UDR 132. This Event-ID indicates to the UDR 132 that the collected data have the purpose of detecting rogue UAVs. At step 9, the UDR 132 answers with a list of UE-IDs for subscriptions which are not registered as UAV or other IoT subscriptions.

At steps 10 and 11, the NWDAF 140 triggers data collection from the AMF 131 with respect to UE mobility. As illustrated, this may involve that for the list of UE-IDs retrieved in step 9, the NWDAF 140 sends a Namf_EventExposure_Subscribe request towards the AMF 131. As illustrated, this request may including the following information: an Event-ID set to “UEMobility”, an area indication corresponding to the area indicated at step 2, and a list of UE-IDs corresponding to the UE-IDs indicated at step 9.

At step 12, the AMF 131 responds to the NWDAF 140, indicating a list of UE-IDs. This list is a subset of the list of UE-IDs from step 9 and includes only those UE-IDs which correspond to the indicated area.

At steps 13 and 14, the NWDAF 140 triggers data collection from the UPF 120 with respect to UE communication. As illustrated, this may involve that, for the list of UE-IDs from step 12, the NWDAF 140 sends a Nupf_EventExposure_Subscribe request to the UPF 120. As illustrated, this request may include the following information: an Event-ID set to “UECommunication” and the list of UE-IDs from step 12. Details of the data collection from the UPF 120 may for example be implemented as described in 3GPP TR 23.700-91 V17.0.0 (2020 December), e.g., may be performed through the SMF or directly. At step 15, the UPF 120 confirms successful operation to the NWDAF 140.

At steps 16 and 17, the UE 10 triggers PDU Session Establishment and generates traffic. The AMF 131 tracks the UE location and gathers data for Event-ID=UEMobility. At steps 18 and 19, the UPF 120 detects UE traffic and gathers data for Event-ID=UECommunication. The UPF 120 forwards UE traffic to the application server 160.

At steps 20 and 21, the AMF 131 continues gathering data for Event-ID=UEMobility and at some point, e.g., defined by a periodic reporting schedule, the AMF 131 reports data for Event-ID=UEMobility to the NWDAF 140. This involves sending a Namf_EventExposure_Notify request to the NWDAF 140. As illustrated, this request may including the following information: Event-ID=UEMobility, UE-ID, and UEMobilityInfo. Here, the information element “UEMobilityInfo” includes mobility information of the UE 10, such as positions and associated timestamps. At step 22, the NWDAF 140 confirms successful operation to the AMF 131.

At steps 23 and 24, the UPF 120 continues gathering data for Event-ID=UECommunication, and at some point, e.g., defined by a periodic reporting schedule, the UPF 120 reports data for Event-ID=UECommunication to the NWDAF 140. This involves sending triggering a Nupf_EventExposure_Notify request to the NWDAF 140. As illustrated, this request may include the following information: Event-ID=UECommunication, UE-ID, and UECommunicationInfo. The information element “UECommunicationInfo” includes information on communication by the UE 10, e.g., indications of user plane activity, a number of flows, IP (Internet Protocol) destinations, or the like. At step 25, the NWDAF 140 confirms successful operation to the UPF 120.

At step 26, the NWDAF 140 produces analytics based on the data collected from the UDR 120, the AMF 131, and the UPF 120. Specifically, the NWDAF 140 derives a list of UE-IDs which correspond to potentially rogue UAVs. For this purpose, the NWDAF 140 may apply a previously trained ML model, e.g., as described in connection with FIG. 3. The NWDAF 140 may base the analytics on positions, speeds, and/or communication patterns respectively associated with the UE-ID. The ML model may be trained based on data collected for regular UAVs and be used to identify a UEs 10 which show similar behavior but are not registered or authorized as UAV, e.g., and are thus suspect of being a rogue UAV. Further indicators of a UE 10 corresponding to a rogue UAV are flight in a forbidden area, at high speed, continuous stops, or low altitude.

At step 27, in case the consumer 250 indicated a Requested-Action at step 2, the network might apply the Requested-Action to the UE-IDs identified as corresponding to a rogue UAV. This may involve that the NWDAF 140 sends a Npcf_Policy Request towards the PCF 133. As illustrated, this request may include the UE-ID and the Requested-Action. At steps 28 and 29, the PCF 133 applies Requested-Action to the UE-ID. Applying the Requested-Action may for example involve triggering redirection of traffic towards a network security entity or towards a certain network slice, e.g., a network slice dedicated for handling rogue UAV traffic. In addition or as an alternative, applying the Requested-Action may involve triggering blocking of traffic or tearing down of connections. In addition or as an alternative, applying the Requested-Action may involve requesting the MNO to disable the MBB subscription associated with the rogue UAV. In addition or as an alternative, applying the Requested-Action may involve triggering reporting of traffic towards an analytics engine, e.g., towards the NWDAF 140. The NWDAF 140 may then use the reported information for further training ML models for rogue UAV detection. In addition or as an alternative, applying the Requested-Action may involve requesting the MNO to apply an authentication service, e.g., by redirecting all non-authenticated connections to an authentication server.

At step 30, the NWDAF 140 reports the analytic output to the NEF 135. This involves sending a Nnwdaf_AnalyticsSubscription_Notify request to the NEF 135. As illustrated, this request may include the following information: Analytic-ID=″Abnormal behaviour “, Analytic-Type=” Rogue UAV″, and Analytic-Result. The information element “Analytic-Result” includes the results of the analytics performed by the NWDAF 140. These results include a list of UE-IDs, which is a subset of the list of UE-IDs indicated at step 5 and corresponds to those UE-IDs which were detected as corresponding to Rogue UAVs. For each UE-ID in the list, the results may include position and estimated trajectory and a confidence metric, which indicates a level of confidence that it is a rogue UAV. The confidence level may for example be indicated as a percentage value. At step 31, the NEF 135 confirms successful operation to the NWDAF 140.

At steps 32 and 33, the NEF 135 forwards the results of the analytics to the consumer 250. This involves that the NEF 135 sends a Nnef_AnalyticsExposure_Notify request to the consumer 250, which includes the information as indicated at step 30. At step 34, the consumer 250 confirms successful operation to the NEF 135. At step 35, the consumer 250 may apply further actions based on the reported results of the analytics, e.g., by adapting UTM operation taking into account the positions and trajectories of the detected rogue UAVs.

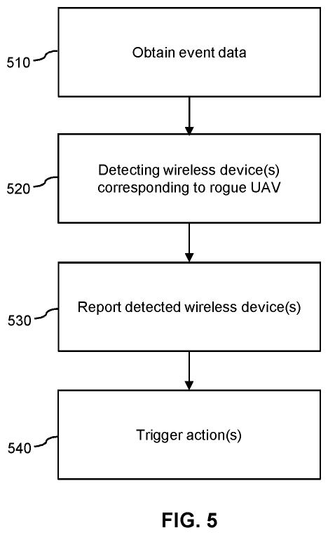

FIG. 5 shows a flowchart for illustrating a method, which may be utilized for implementing the illustrated concepts. The method of FIG. 5 may be used for implementing the illustrated concepts in a node of a wireless communication network, e.g., corresponding to the above-mentioned NWDAF 140 or analytics system 300.

If a processor-based implementation of the node is used, at least some of the steps of the method of FIG. 5 may be performed and/or controlled by one or more processors of the node. Such node may also include a memory storing program code for implementing at least some of the below described functionalities or steps of the method of FIG. 5.

At step 510, the node obtains event data related to one or more wireless devices connected to the wireless communication network. Such event data may be collected by one or more other nodes of the wireless communication network and reported to the node. The wireless devices may be UEs. Some of these wireless devices may be UAVs. The event data may include mobility data indicative of mobility of the one or more wireless devices, e.g., data indicating position of the wireless device and corresponding time information. In addition or as an alternative, the event data may include communication data indicative of data communication between the one or more wireless devices and the wireless communication network, e.g., data indicative of user plane activity of the one or more wireless devices, data describing one or more data flows established the one or more wireless devices, or data indicative of communication destinations of the one or more wireless devices. In some scenarios, the event data may be filtered based on a geographical area of interest, based on a list of identifiers of the one or more wireless devices, and/or based on one or more other filtering criteria.

At step 520, the node detects that at least one of the one or more wireless devices corresponds to a rogue UAV. This detection is based on analyzing the event data obtained at step 510. In some scenarios, the analyzing of the event data is based on an ML model, e.g., as described in connection with FIG. 3. The ML model can be trained based on training event data related to one or more wireless devices classified as rogue UAV. Alternatively, the ML model can trained based on training event data related to one or more wireless devices classified as regular UAV, i.e., an authorized and registered UAV. Such training data may be collected by one or more other nodes of the wireless communication network and reported to the node. In some scenarios, the ML model is based on reinforcement learning. However, the ML model could also be based on other types of ML algorithm, e.g., supervised learning or unsupervised learning. In some scenarios, the node may perform the analysis and detection of step 520 in response to a subscription from the aircraft traffic management system, e.g., as described in connection with steps 1 to 6 of FIG. 4A.

At step 530, the node reports the detected at least one wireless device to an aircraft traffic management system, such as the above-mentioned UTM. 14. The reporting of step 530 may involve indicating an identifier of the detected at least one wireless device. Alternatively or in addition, the reporting of step 530 may involve indicating a position of the detected at least one wireless device. Alternatively or in addition, the reporting of step 530 may involve indicating an estimated future trajectory of the detected at least one wireless device. Alternatively or in addition, the reporting of step 530 may involve indicating a metric representing a level of confidence that the detected at least one wireless device corresponds to a rogue UAV. In some scenarios, the node may perform the reporting of step 530 in response to a subscription from the aircraft traffic management system, e.g., as described in connection with steps 1 to 6 of FIG. 4A.

At step 540, the node may trigger at least one action for the detected at least one wireless device. The at least one action may include one or more of: redirecting traffic of the detected at least one wireless device, blocking traffic of the detected at least one wireless device, disabling a subscription associated with the detected at least one wireless device, reporting traffic of the detected at least one wireless device, and enforcing authentication of the detected at least one wireless device, e.g., as explained in connection with step 28 of FIG. 4B. In some scenarios, the node may perform the triggering of step 540 in response to a subscription from the aircraft traffic management system, e.g., as described in connection with steps 1 to 6 of FIG. 4A.

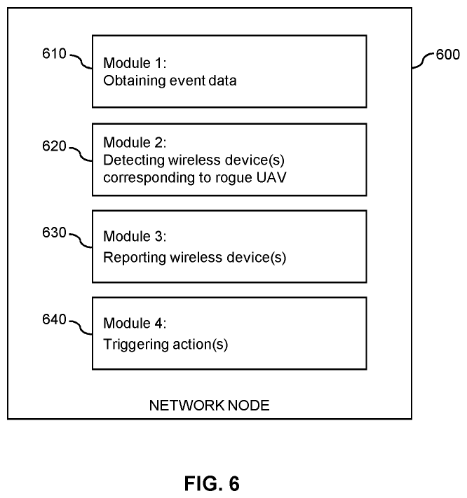

FIG. 6 shows a block diagram for illustrating functionalities of a node 600 for a wireless communication network which operates according to the method of FIG. 5. The node 600 may for example correspond to or implement the above-mentioned NWDAF 140 or analytics system 300. As illustrated, the node 600 may be provided with a module 610 configured to obtain event data, such as explained in connection with step 510. Further, the node 600 may be provided with a module 620 configured to detect at least one wireless device corresponding to a rogue UAV, such as explained in connection with step 520. Further, the node 600 may be provided with a module 630 configured to report the detected at least one wireless device, such as explained in connection with step 530. Further, the node 600 may be provided with a module 640 configured to trigger at least one action, such as explained in connection with step 540.

It is noted that the node 600 may include further modules for implementing other functionalities, such as known functionalities of an NWDAF or similar analytics node. Further, it is noted that the modules of the node 600 do not necessarily represent a hardware structure of the node 600, but may also correspond to functional elements, e.g., implemented by hardware, software, or a combination thereof.

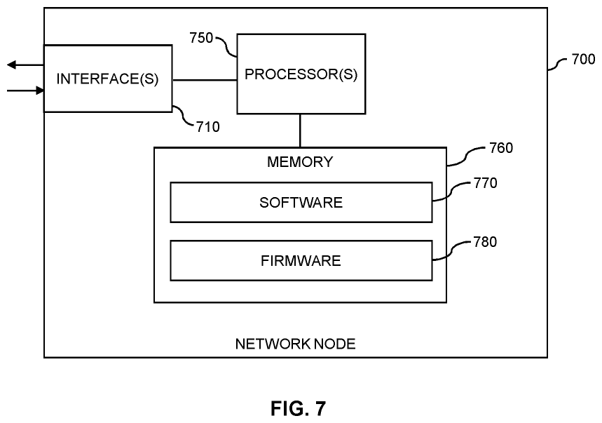

FIG. 7 schematically illustrates a processor-based implementation of a node 700 for a wireless communication network, which may be used for implementing the above-described concepts. For example, the structures as illustrated in FIG. 7 may be used for implementing the concepts in the above-mentioned NWDAF 140 or analytics system 300.

As illustrated, the node 700 may include one or more interfaces 710. The interface(s) 710 may be used for communication with one or more other nodes of the wireless communication network, e.g., other CN nodes, or with an external aircraft management system, such as the above-mentioned UTM 250.

Further, the node 700 may include one or more processors 750 coupled to the interface(s) 710 and a memory 760 coupled to the processor(s) 750. By way of example, the interface(s) 710, the processor(s) 750, and the memory 760 could be coupled by one or more internal bus systems of the node 700. The memory 760 may include a read-only memory (ROM), e.g., a flash ROM, a random-access memory (RAM), e.g., a dynamic RAM (DRAM) or static RAM (SRAM), a mass storage, e.g., a hard disk or solid state disk, or the like. As illustrated, the memory 1060 may include software 770 and/or firmware 780. The memory 760 may include suitably configured program code to be executed by the processor(s) 750 so as to implement the above-described functionalities for detecting rogue UAVs, such as explained in connection with FIG. 5.

It is to be understood that the structures as illustrated in FIG. 7 are merely schematic and that the node 700 may actually include further components which, for the sake of clarity, have not been illustrated, e.g., further interfaces or further processors. Also, it is to be understood that the memory 760 may include further program code for implementing known functionalities of a NWDAF or similar analytics node. According to some embodiments, also a computer program may be provided for implementing functionalities of the node 700, e.g., in the form of a physical medium storing the program code and/or other data to be stored in the memory 760 or by making the program code available for download or by streaming.

As can be seen, the concepts as described above may be used for efficiently handling and managing wireless communication associated with UAVs, in particular considering the possibility that a UE connected to a wireless communication network could also be a rogue UAV which is not registered as UAV and not authorized by a UTM or similar aircraft management system. As a result, safety of UAS operation may be improved and hazards caused by rogue UAVs can be avoided.

It is to be understood that the examples and embodiments as explained above are merely illustrative and susceptible to various modifications. For example, the illustrated concepts may be applied in connection with various kinds of wireless communication technologies, without limitation to the NR technology or LTE technology specified by 3GPP. Further, the concepts may be applied with respect to various types of aircraft management system and UAV. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1. A method of controlling wireless communication, the method comprising:
a node of a wireless communication network obtaining event data related to one or more wireless devices connected to the wireless communication network;
based on analyzing the event data, the node detecting that at least one of the one or more wireless devices corresponds to a rogue unmanned aerial vehicle, UAV; and
the node reporting the detected at least one wireless device to an aircraft traffic management system.

2. The method of claim 1, wherein the event data comprise mobility data indicative of mobility of the one or more wireless devices.

3. The method of claim 2, wherein the mobility data comprise data indicating position of the wireless device and corresponding time information.

4. The method of claim 1, wherein the event data comprise communication data indicative of data communication between the one or more wireless devices and the wireless communication network.

5. The method of claim 4, wherein the communication data comprise data indicative of user plane activity of the one or more wireless devices.

6. The method of claim 4, wherein the communication data comprise data describing one or more data flows established the one or more wireless devices.

7. The method of claim 4, wherein the communication data comprise data indicative of communication destinations of the one or more wireless devices.

8. The method of claim 1, wherein the event data are filtered based on a geographical area of interest.

9. The method of claim 1, wherein the event data are filtered based on a list of identifiers of the one or more wireless devices.

10. (canceled)

11. The method of claim 1, wherein
said analyzing of the event data is based on a machine learning model, and
the machine learning model is trained based on training event data related to one or more wireless devices classified as rogue UAV.

12. The method of claim 1, wherein
said analyzing of the event data is based on a machine learning model, and
the machine learning model is trained based on training event data related to one or more wireless devices classified as regular UAV.

13. The method of claim 1, wherein
said analyzing of the event data is based on a machine learning model, and
the machine learning model is based on reinforcement learning.

14. The method of claim 1, wherein said reporting comprises indicating an identifier of the detected at least one wireless device.

15. The method of claim 1, wherein said reporting comprises indicating a position of the detected at least one wireless device.

16. The method of claim 1, wherein said reporting comprises indicating an estimated future trajectory of the detected at least one wireless device.

17. The method of claim 1, wherein said reporting comprises indicating a metric representing a level of confidence that the detected at least one wireless device corresponds to a rogue UAV.

18. The method of claim 1, further comprising:
triggering at least one action for the detected at least one wireless device, wherein
the at least one action comprises one or more of: redirecting traffic of the detected at least one wireless device, blocking traffic of the detected at least one wireless device, disabling a subscription associated with the detected at least one wireless device, reporting traffic of the detected at least one wireless device, and enforcing authentication of the detected at least one wireless device.

19. (canceled)

20. The method of claim 1, wherein the node performs said analyzing and reporting in response to a subscription from the aircraft traffic management system.

21. A node for a wireless communication network, the node comprising:
a processing unit, and
a memory containing program code executable by the processing unit, wherein the node is configured to:
obtain event data related to one or more wireless devices connected to the wireless communication network;
based on analyzing the event data, detect that at least one of the one or more wireless devices corresponds to a rogue unmanned aerial vehicle, UAV; and
report the detected at least one wireless device to an aircraft traffic management system.

22-23. (canceled)

24. A non-transitory computer readable storage medium storing program code to be executed by at least one processor of a node of a wireless communication network, wherein execution of the program code causes the node to perform the method of claim 1.
